(19) United States
(12) Patent Application Publication
(10) Pub. No.: US 2020/0267917 A1
(43) Pub. Date: Aug. 27, 2020

(54) SELF-WATERING PLANTER

(71) Applicants: Omri Hulday, Tzelafon (IL); Ilan Lior, Gizo (IL)

(72) Inventors: Omri Hulday, Tzelafon (IL); Ilan Lior, Gizo (IL)

(21) Appl. No.: 16/283,779

(22) Filed: Feb. 24, 2019

(51) Int. Cl. A01G 27/06; A01G 9/02; A01G 9/24; A01G 29/00; A01G 25/16; A01G 27/00

(52) U.S. Cl. CPC A01G 27/06; A01G 9/02; A01G 9/247; A01G 27/005; A01G 25/167; A01G 27/001; A01G 27/008; A01G 29/00

(57) ABSTRACT

A planter assembly includes a reservoir including a flexible container which includes an inlet port for introducing liquid therein and an outlet tube. One end of the outlet tube points towards a bottom portion of the container and the other end of the outlet tube is in fluid communication with an outlet port. Filler elements partially fill the container and prevent the container from contracting beyond a limit.

### FIELD OF THE INVENTION

The present invention relates generally to plant containers, such as flower beds and planters and the like, and particularly to a self-watering planter with its own independent water reservoir.

### BACKGROUND OF THE INVENTION

Flowers and other plants are very popular for many indoor applications, including indoor gardens, ornamental arrangements, hotel or business lobbies and many more. For example, greenery provides a breath of fresh air that contributes to a feeling of calm and relaxation in a lobby. Relaxed and happy customers are more likely to spend time in the lobby and make use of the facilities, thereby increasing income for the hotel or business.

Plants rely on water as a transport mechanism in order to draw nutrients from the soil into the plants through the roots and into the stems, leaves, and so forth. Water also acts as a transpiration cooling mechanism by evaporation out through the leaves and other foliage of a plant. However, indoor plant locations such as malls, homes, offices, and the like, receive little or no rainfall. Irrigation or periodic watering by some mechanism is required. Additionally, when used indoors the planter must have proper drainage; otherwise, excess water will drip on the floor. In contrast, by watering the required amount, the plant uses most of the water and the required drainage is either eliminated or significantly reduced.

Planters of the self-watering type, wherein a reservoir of water is maintained for the plant, are well known. However, prior art self-watering planters have several disadvantages.

Some plant-watering systems use a pump that pumps water from a reservoir to the soil. However, the reservoir is a rigid container because it not only must contain the required volume of water, it must also withstand the weight of soil above it. Thus, the reservoir takes up a significant volume of the system.

### SUMMARY OF THE INVENTION

The present invention seeks to provide a self-watering planter with its own independent water reservoir, as is described more in detail hereinbelow. The term “planter” encompasses any device that includes a plant growth medium for providing nutrients (including water) to maintain life of a plant planted in the plant growth medium. The device is typically placed indoors, but may also be placed outdoors.

There is provided in accordance with a non-limiting embodiment of the invention an assembly including a reservoir including a flexible container which includes an inlet port for introducing liquid therein, and an outlet tube with a first end and a second end, the first end pointing towards a bottom portion of the container and the second end in fluid communication with an outlet port, and filler elements that partially fill the container and prevent the container from contracting beyond a limit.

In accordance with a non-limiting embodiment of the invention the inlet port is sealed by an inlet seal that prevents leakage of liquid at the inlet port. The outlet port may be sealed by an outlet seal that prevents leakage of liquid at the outlet port.

In accordance with a non-limiting embodiment of the invention the container includes an expansion limiter configured to limit expansion of the container after introduction of a liquid into the container. The expansion limiter may include a band disposed about a portion of the container. The filler elements may include spheres or other geometric or irregular shapes, made of plastics or other suitable materials.

In accordance with a non-limiting embodiment of the invention a fill tube is in fluid communication with the inlet port. A pump is in fluid communication with the outlet port and with an irrigation tube. The pump may be coupled to a controller operative to control operation of the pump. In one embodiment, the pump may be submersible.

In accordance with a non-limiting embodiment of the invention the reservoir and the filler elements, which are in the container, are disposed in a planter housing.

In accordance with a non-limiting embodiment of the invention the reservoir and the filler elements are located on a bottom inner surface of the planter housing and the planter housing is at least partially filled with a plant growth medium placed on top of the reservoir.

In accordance with a non-limiting embodiment of the invention the reservoir and the filler elements are located on a side inner surface of the planter housing and the planter housing is at least partially filled with a plant growth medium placed on the side of the reservoir.

In accordance with a non-limiting embodiment of the invention a moisture sensor is configured to measure a moisture characteristic of the plant growth medium, and the controller is operative to control operation of the pump with feedback from the moisture sensor.

In accordance with a non-limiting embodiment of the invention a method is provided for using a planter housing including placing a reservoir in a planter housing, the reservoir including a flexible container which includes an inlet port for introducing liquid therein, and an outlet tube with a first end and a second end, the first end pointing towards a bottom portion of the container and the second end in fluid communication with an outlet port, and filler elements that partially fill the container and prevent the container from contracting beyond a limit, and at least partially filling the planter housing with a plant growth medium placed on top or on side of the reservoir.

The method may further include planting a plant in the plant growth medium, at least partially filling the reservoir with liquid that promotes growth of the plant, fluidly coupling a pump with the outlet port and with an irrigation tube, and using the pump to cause the liquid to exit the reservoir via the outlet port, to flow through the irrigation tube and to irrigate the plant.

### BRIEF DESCRIPTION OF THE DRAWINGS

The present invention will be understood and appreciated more fully from the following detailed description taken in conjunction with the drawings in which:

FIG. 1 is a simplified pictorial illustration of a planter assembly with its own independent water reservoir, constructed and operative in accordance with a non-limiting embodiment of the present invention;

FIG. 2 is a simplified pictorial illustration of the planter with a controlled pumping system and a fill-tube connected to the reservoir;

FIG. 3 is a simplified pictorial illustration of the planter with growth medium;

FIGS. 4A-4B are simplified pictorial illustrations of the planter with a different version of a water reservoir, in accordance with a non-limiting embodiment of the present invention, respectively before and after connection to a controlled pumping system and a fill-tube;

FIGS. 5A, 5B and 5C are simplified pictorial illustrations of the planter with different methods of liquid and air inlet and liquid outlet;

FIG. 6 is a simplified pictorial illustration of the planter with a submerged pump; and

FIG. 7 is a simplified pictorial illustration of a planter assembly with its own independent water reservoir, in which liquid flows to the plant by capillary action, constructed and operative in accordance with another non-limiting embodiment of the present invention.

### DETAILED DESCRIPTION OF EMBODIMENTS

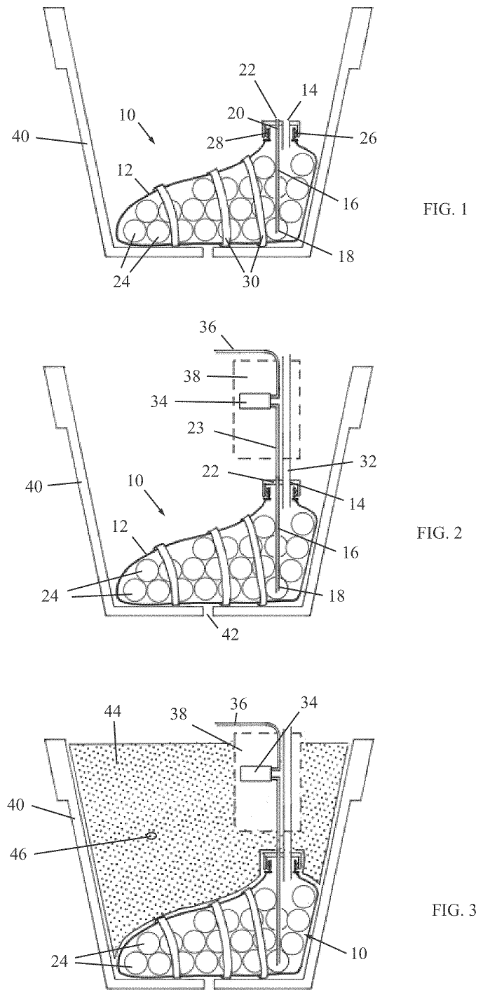

Reference is now made to FIG. 1, which illustrates a planter assembly, constructed and operative in accordance with a non-limiting embodiment of the present invention;

The assembly includes a reservoir 10 including a flexible container 12 which includes an inlet port 14 for introducing liquid therein, and an outlet tube 16. The flexible container 12 may be made of any suitable plastic or metal material, such as but not limited to, polyurethane, polyethylene terephthalate, aluminum foil and many others. Outlet tube 16 has a first end 18 and a second end 20. The first end 18 points towards a bottom portion of container 12 and second end 20 is in fluid communication with an outlet port 22.

Alternatively, the invention may be carried out with only one tube that serves as an inlet-outlet tube. As another alternative, the inlet and/or outlet do not have to be a tube, cut instead may be fabric material, such as geothermic fabric, in which the liquid is not pumped but instead permeates through the fabric.

Filler elements 24 partially fill container 12 and prevent container 12 from contracting beyond a limit (the limit may be predefined to minimum volume required for storing sufficient liquid for sustaining plant life for a predefined period of time). The filler elements 24 may include polymeric spheres or other geometric or irregular shapes. Filler elements 24 may be made of, without limitation, polystyrene, polyurethane, polysulfone, polyimide, polyethylene terephthalate and many others. Filler elements 24 may be solid or hollow with holes (allows water to fill inside the filler elements).

Inlet port 14 may be sealed by an inlet seal 26 that prevents leakage of liquid at inlet port 14. Outlet port 20 may be sealed by an outlet seal 28 that prevents leakage of liquid at outlet port 20.

Container 12 may include an expansion limiter 30 configured to limit expansion of container 12 after introduction of filling elements into container 12. Expansion limiter 30 may include one or more bands disposed about a portion of container 12. Expansion limiter 30 may be made of, without limitation, plastic or metal or fabric.

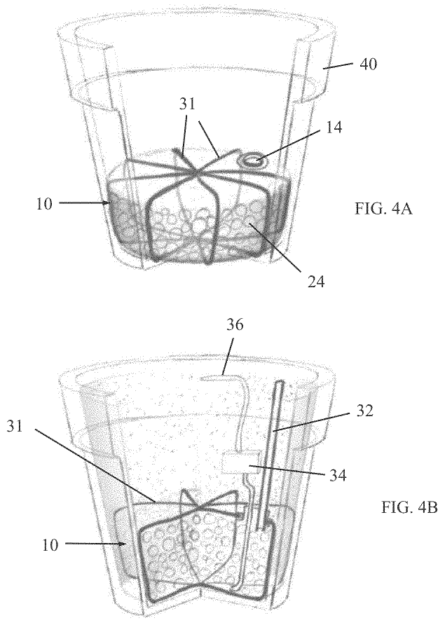

FIGS. 4A-4B illustrate another version of an expansion limiter 31, in which radial bands are disposed around the reservoir 10. Many other types of expansion limiters may be used.

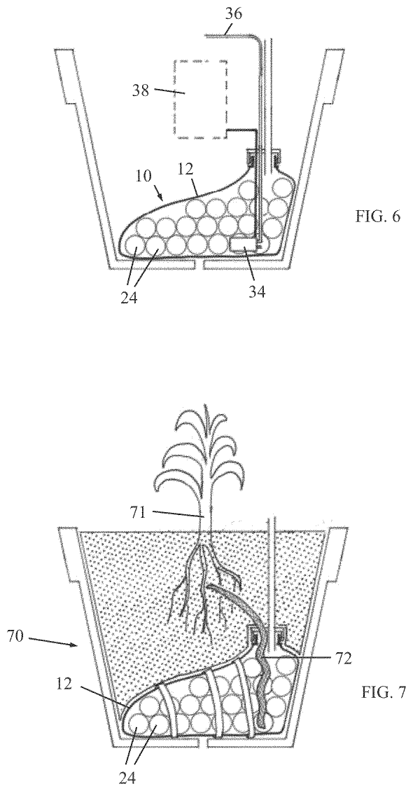

As seen in FIG. 2, a fill tube 32 may be in fluid communication with inlet port 14. A pump 34 may be in fluid communication with outlet port 22 and with an irrigation tube 36. (Pump 34 may be coupled to outlet port 22 via a tube 23.) Pump 34 may be coupled to a controller 38 operative to control operation of pump 34. Pump 34 may be any kind of suitable pump, such as but not limited to, a peristaltic pump, a diaphragm pump, a dosing pump, a reciprocating pump, centrifugal pump, and many others. Controller 38 may be external to the assembly, such as a cloud-based controller or an application on a personal communication device. Pump 34 may pump water, fertilizer, nutrients or any substance the plant may require. As seen in FIG. 6, pump 34 may be submerged instead of being external.

As seen in FIGS. 1-3, reservoir 10, with its filler elements 24, is disposed in a planter housing 40. Housing 40 may have a drainage hole 42 (FIG. 2).

As seen in FIG. 3, reservoir 10 and its filler elements 24 are located on a bottom inner surface of planter housing 40. Planter housing 40 is at least partially filled with a plant growth medium 44 placed on top of reservoir 10. The plant growth medium 44 includes, without limitation, different types of soils, such as rocky soil, sandy soil, clay soil, organic soil or organic matter, loam, foliage, decaying plant matter, peat moss and the like.

In accordance with a non-limiting embodiment of the invention a moisture sensor 46 is configured to measure a moisture characteristic of plant growth medium 44. As is well known in the art, moisture sensor 46 may sense a change in electrical resistance or capacitance in the plant growth medium 44 or a change in pH or other chemical property, and many others. Controller 38 may control operation of pump 34 with feedback from moisture sensor 46.

The reservoir 10 may be provided without the planter housing 40 as an add-on device for converting any planter housing into a self-watering planter. In this manner, the user, such as a hotel chain, does not have to purchase new planters, but rather is free to choose any planter and convert that planter into a smart self-watering planter since the flexible container can be adjusted to fit any size or shape of the planter. Alternatively, reservoir 10 may be provided together with the planter housing 40 by the planter housing manufacturer or supplier.

If container 12 did not have the filler elements 24, then container 12 could collapse under the weight of soil or other plant growth medium or after liquids have been disposed. The filler elements 24 prevent such a collapse and significantly reduce the pumping effort required to fill the reservoir 10. The filler elements have another advantage by not occupying much volume. With the filler elements 24, the container 12 occupies significantly less volume than prior art double-walled reservoirs. This enables implementing the assembly in a limitless range of planter housing sizes and styles.

In the above embodiments, the outlet permits liquid to flow from the container to the plant growth medium. The inlet has a dual purpose: air can enter the container to replace the liquid that flows out of container, and fresh liquid can enter the container to replace liquid that has flowed out of the container.

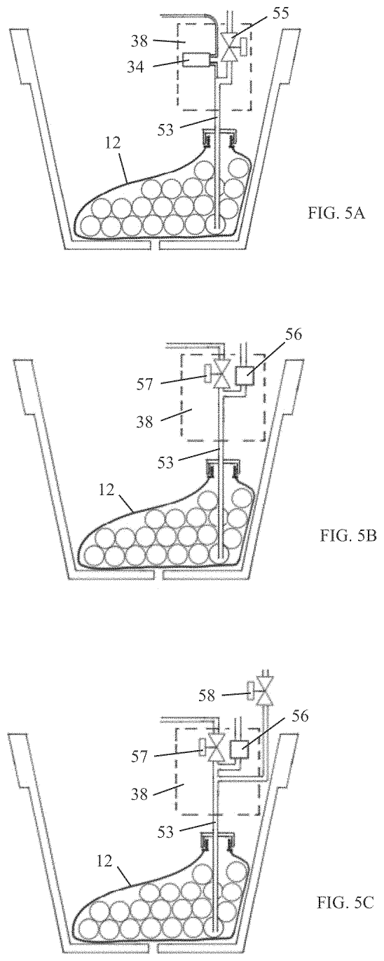

FIGS. 5A-5C illustrate other embodiments, in which the liquid flow in and out of the container plus the air flow is accomplished with one multi-purpose tube instead of a dedicated inlet and a dedicated outlet.

In FIG. 5A, pump 34 pumps liquid out of container 12 through a single tube 53. This lowers the pressure inside container 12. A valve 55, which may be automatically controlled by the controller or by other means, opens to allow air to enter container 12 through tube 53 (air flows into container 12 due to the lower pressure there compared to the outside which is at a higher pressure).

In FIG. 5B, there is no need for a pump. Instead, a compressor 56 compresses air into the container 12, thereby raising the pressure inside container 12. A valve 57, which may be automatically controlled by the controller or by other means, opens to allow liquid to exit container 12 via the single tube 53. The liquid flows out of container 12 due to the higher pressure from the compressor 56, so there is no need for a pump. In such an embodiment, fresh liquid may be introduced into container 12 through the single tube 53 after the required amount of liquid has exited the container 12.

In FIG. 5C, fresh liquid may be introduced into container 12 through a bypass tube 58 that bypasses the compressor 56.

Reference is now made to FIG. 7, which illustrates a planter assembly 70 with its own independent water reservoir 12, in which liquid flows to a plant 71 by capillary action, such as through a wick 72. Wick 72 may be made of any suitable material, such as cotton or synthetic fibers, spun, woven or non-woven, for example. The term “wick” encompasses any pathway for fluid movement by capillary action.

What is claimed is:

1. An assembly comprising:
a reservoir comprising a flexible container comprising an outlet for liquid to exit said flexible container; and
filler elements that partially fill said flexible container and prevent said flexible container from contracting beyond a limit.

2. The assembly according to claim 1, wherein said flexible container comprises an inlet port.

3. The assembly according to claim 2, wherein said inlet port is sealed by an inlet seal that prevents leakage of liquid at said inlet port.

4. The assembly according to claim 1, wherein said outlet is sealed by an outlet seal that prevents leakage of liquid at said outlet port.

5. The assembly according to claim 1, wherein said container comprises an expansion limiter configured to limit expansion of said container after introduction of a liquid into said container.

6. The assembly according to claim 5, wherein said expansion limiter comprises a band disposed about a portion of said container.

7. The assembly according to claim 1, wherein said filler elements comprise polymeric spheres.

8. The assembly according to claim 2, further comprising a fill tube in fluid communication with said inlet port.

9. The assembly according to claim 1, further comprising a pump in fluid communication with said outlet port and with an irrigation tube.

10. The assembly according to claim 9, wherein said pump is coupled to a controller operative to control operation of said pump.

11. The assembly according to claim 1, wherein said reservoir and said filler elements, which are in said container, are disposed in a planter housing.

12. The assembly according to claim 1, wherein said reservoir and said filler elements are located on a bottom or side inner surface of said planter housing and said planter housing is at least partially filled with a plant growth medium placed on top of, alongside or below said reservoir.

13. The assembly according to claim 12, further comprising a moisture sensor configured to measure a moisture characteristic of said plant growth medium, said moisture sensor being in communication with a controller which is coupled to a pump, said pump being in fluid communication with said outlet port and with an irrigation tube, and wherein said controller is operative to control operation of said pump with feedback from said moisture sensor.

14. The assembly according to claim 1, wherein said outlet comprises a wick.

15. A method for using a planter housing comprising:
placing a reservoir in a planter housing, said reservoir comprising a flexible container and an outlet tube with a first end and a second end, said first end pointing towards a bottom portion of said container and said second end in fluid communication with an outlet port; and filler elements that partially fill said container and prevent said container from contracting beyond a limit; and
at least partially filling said planter housing with a plant growth medium placed on top of, alongside or below said reservoir.

16. The method according to claim 15, further comprising:
planting a plant in said plant growth medium;
at least partially filling said reservoir with liquid that promotes growth of said plant;
fluidly coupling a pump with said outlet port and with an irrigation tube; and
using said pump to cause said liquid to exit said reservoir via said outlet port, to flow through said irrigation tube and to irrigate said plant.
